(19) United States
(12) Patent Application Publication
(10) Pub. No.: US 2018/0189754 A1
(43) Pub. Date: Jul. 5, 2018

(54) SYSTEM AND METHOD OF BATCH PROCESSING PAYMENT TRANSACTIONS

(71) Applicants: Adam C Campbell, American Fork, UT (US); Michael Phaedok, Orem, UT (US)

(72) Inventors: Adam C Campbell, American Fork, UT (US); Michael Phaedok, Orem, UT (US)

(21) Appl. No.: 15/458,589

(22) Filed: Mar. 14, 2017

Related U.S. Application Data
(60) Provisional application No. 62/440,556, filed on Dec. 30, 2016.

(51) Int. Cl. G06Q 20/10; G06Q 20/40

(52) U.S. Cl. CPC G06Q 20/10; G06Q 20/405

(57) ABSTRACT

A system and method of batch processing payment transactions comprises a memory unit and a processor. The processor executes a set of program modules comprising an input module, a payment batching module, and a payment transaction processor module. The input module receives information associated with at least one transaction bundle. The at least one transaction bundle comprises at least one payment transaction associated with a first payment destination account. The payment batching module assigns a second payment destination account to a payment batch among a plurality of payment batches. The payment batching module selectively assigns the at least one payment transaction to the payment batch, based on the first payment destination account being identical to the second payment destination account. The payment transaction processor module processes the at least one payment transaction in the plurality of payment batches on a batch basis.

### BACKGROUND OF THE INVENTION

### A. Technical Field

The present invention generally relates to the technical field of payment systems, and more specifically relates to a system and method for batch processing payment transactions.

### B. Description of Related Art

The advent of eCommerce in the last two decades has spawned a plethora of web-based retail companies, web-based product companies, and web-based service companies. Consequently, the past two decades have witnessed an exponential increase in number of web-based payment transactions processed per day. In recent years, the web based payment transactions have been brought under control of a slew of government regulations, and has been under constant threat by hackers, and internet scammers. Hence, every year, software developers, cryptographers, and banking administrators churn out increasingly secure, impregnable and complex methods to process web-based payment transactions. With increase in complexity in processing web-based payment transactions, processing fee for performing each web-based payment transaction has also increased multifold. The eCommerce companies often find it monetarily beneficial to reduce number of web-based payment transactions needed to conduct eCommerce.

Price of a product in a market is usually a sum of cost of making the product, taxes associated with the product, and a service fee for processing the web-based payment transactions. Obviously, the cost of making the product, the taxes associated with the product, and the service fee for processing the web-based payment transactions must be segregated and electronically transmitted to different monetary accounts as separate subsidiary web-based payment transactions. Thus, purchase of the product necessitates processing of a plurality of subsidiary web-based payment transactions and cumulative processing fee of the plurality of subsidiary web-based payment transactions becomes gargantuan. The plurality of subsidiary web-based payment transactions is received from the eCommerce company in form of a transaction bundle. It is argued that the cumulative processing fee of the plurality of subsidiary web-based payment transactions can be diminished considerably by batch processing web-based payment transactions comprised in the transaction bundle.

Thus, there is a need for a secure system and method for batch processing payment transactions.

### SUMMARY OF THE INVENTION

The present invention relates to a system and method for batch processing payment transactions.

In one embodiment of the present invention, a system for batch processing payment transactions comprises a memory unit to store a set of program modules. A processor executes the set of program modules. The set of program modules comprises an input module, a payment batching module, a payment transaction processor module. The input module, is configured to receive from at least one proxy user information associated with at least one transaction bundle, wherein the at least one transaction bundle comprises at least one payment transaction comprising a payment amount to be electronically transferred to a first payment destination account. The payment batching module is configured to assign a second payment destination account to a payment batch among a plurality of payment batches, and to selectively assign the at least one payment transaction to the payment batch, based on the first payment destination account being identical to the second payment destination account. The payment transaction processor module, is configured to process the at least one payment transaction in the plurality of payment batches on a batch basis.

In one embodiment of the present invention, the memory unit further stores a plurality of trusted Application Programming Interface (API) keys and a plurality of trusted user credentials. The system further comprises an authorization module executed by the processor, configured to receive at least one user credential from at least one user, compare the at least one user credential with each of the plurality of trusted user credentials, authenticate the at least one user based on the at least one user credential being identical to at least one of the plurality of trusted user credentials, receive from the at least one user, an instruction to authorize a first proxy user, generate a first API key for the first proxy user, and store the first API key in the memory unit. The authorization module is further configured to receive an API key from the at least one proxy user, compare the API key to each of the plurality of trusted API keys, and authenticate the at least one proxy user based on the API key being identical to at least one of the plurality of trusted API keys. The at least one proxy user is associated with at least one Application Programming Interface endpoint. The payment batching module writes the plurality of payment batches into a payout file. The at least one API endpoint produce information in Representational State Transfer (REST) style. The authorization module generates a session key for the at least one user. The session key expires within a predefined time interval of generation of the session key. The API key comprises a plurality of permission levels associated with the at least one proxy user.

In another embodiment of the present invention, a method of batch processing payment transactions comprises storing in a memory unit, a set of program modules. Further, the method comprises, receiving from at least one proxy user by a processor via an input module, information associated with at least one transaction bundle, wherein the at least one transaction bundle comprises at least one payment transaction comprising a payment amount to be electronically transferred to a first payment destination account. Further, the method comprises, assigning by the processor via a payment batching module, a second payment destination account to a payment batch among a plurality of payment batches. Further, the method comprises, selectively assigning by the processor via the payment batching module, the at least one payment transaction to the payment batch, based on the first payment destination account being identical to the second payment destination account. Further, the method comprises, processing by the processor via a payment transaction processor module, the at least one payment transaction in the plurality of payment batches on a batch basis.

### BRIEF DESCRIPTION OF DRAWINGS

FIG. 1 is a block diagram of an environment implemented in accordance with various embodiments of the invention.

FIG. 2 is a flowchart of a method of batch processing payment transactions in accordance with an embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

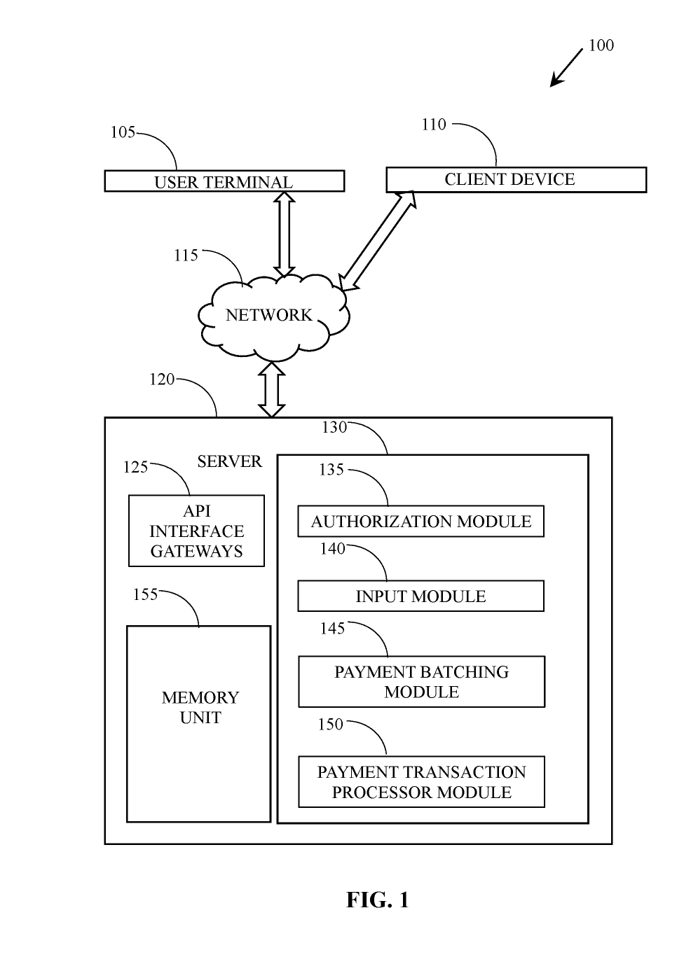

FIG. 1 is a block diagram of an environment 100 implemented in accordance with various embodiments of the invention. The environment 100 comprises a user terminal 105, a client device 110, a network 115, and a server 120. The client device 110 and the user terminal 105 communicates with the server 120 via the network 115. Examples of the network 115 include, but are not limited to local area networks, mobile networks, internet, wide area networks, and Bluetooth networks.

At least one user uses the network 115 to communicate with the server 120 via the user terminal 105. The user terminal 105 is at least one of a personal computer, a tablet computer, a laptop, a smartphone, and a smart television. Further, the client device 110 hosts a plurality of application programs. The plurality of application programs communicates with the server 120 via one or more Application Programming Interface (API) gateways 120. The API gateways 120 communicate with the server 120 via at least one proxy user. In one example, the plurality of application programs in the client device 110, the user terminal 105 and the server 120 are provided interoperability by Representational State Transfer (REST) based web services.

The plurality of application programs comprises mobile applications, eCommerce websites, electronic wallet applications, payment processing websites, credit card applications, debit card applications, banking websites, web form applications, and electronic customer relationship management software.

The environment 100 hosts a system for batch processing payment transactions received from the at least one proxy user. In one example, the system for batch processing payment transactions is implemented in the server 120. The system is implemented as middleware. The server 120 comprises a memory unit 155 and a processor 130. The memory unit 155 stores a set of program modules comprising an authorization module 135, an input module 140, a payment batching module 145, and a payment transaction processor module 150. Further, the memory unit 155 stores a plurality of permission levels associated with the proxy user, a plurality of trusted API keys and a plurality of trusted user credentials. The processor 130 executes the set of program modules stored in the memory unit 155.

As mentioned above, the set of program modules comprises the authorization module 135, configured to receive at least one user credential from the user. Examples of the user credential include, but are not limited to passwords, usernames, fingerprints, retinal scans, voice samples, biometric parameters, and facial images. The authorization module 135 compares the user credential with each of the plurality of trusted user credentials stored in the memory unit 155. If the user credential is identical to at least one of the plurality of trusted user credentials, then the authorization module 135 authenticates the user. In one example, after authentication, the user becomes a system administrator.

After authenticating the user, the authorization module 135 generates a session key for the user. The session key has a pre-defined lifetime. In one example, the predefined lifetime is fifteen minutes. After expiry of the predefined lifetime, the authorization module 135 deactivates the session key. The user is enabled to set the session key to at least one application program in the client device 110. Furthermore, the user, after being authenticated, is enabled to authorize the proxy user to the server 120.

In one example, after authorization of the proxy user, the authorization module 135 generates an Application Programming interface (API) key for the proxy user. The API key comprises information regarding permission levels associated with the proxy user. An example of a permission level includes, but is not limited to a permission to update a plurality of electronic monetary accounts, a permission to process a plurality of electronic sales transactions, and a permission for the proxy user to generate a payout file. The authorization module 135 stores the API key in the memory unit 155. Role of the proxy user in the system is configurable by the user by means of controlling permission levels of the proxy user.

In another example, the authorization module 135 is configured to receive an API key from at least one proxy user. The authorization module 135 compares the API key to each of the plurality of trusted API keys stored in the memory unit 155. Further, the authorization module 135 authenticates the proxy user based on the API key being identical to at least one of the plurality of trusted API keys. The proxy user, after being authenticated is enabled to transfer at least one transaction bundle into the server 120 via the input module 140.

The input module 140, is configured to receive from the at least one proxy user, information associated with the transaction bundle. The transaction bundle comprises at least one payment transaction comprising a first payment amount to be electronically transferred to a first payment destination account. Examples of first payment destination include electronic wallet accounts, bank accounts, debit card balances, credit card balances, and store credits.

In one example, the transaction bundle comprises a plurality of payment transactions comprising a tax payment transaction, a user payment transaction and a merchant payment transaction. In an exemplary illustration of the present invention, the tax payment transaction comprises a tax amount to be transferred to a tax account. In another exemplary illustration of the present invention, the user payment transaction comprises a user payment amount to be electronically transferred to a user bank account. In yet another exemplary illustration of the present invention, the merchant payment transaction comprises a merchant payment amount to be electronically transferred to a merchant bank account. In one example, the payment transactions are processed in a batch basis by a combination of a payment batching module 145 and a payment transaction processor module 150.

The payment batching module 145, is configured to assign a second payment destination account to a payment batch among a plurality of payment batches. In one example, each payment batch among the plurality of payment comprises a second payment amount to be electronically transferred to the second payment destination account. Further, the payment batching module 145 selectively assigns the at least one payment transaction to the payment batch, based on the first payment destination account being identical to the second payment destination account. The payment batching module 145 writes the plurality of payment batches into a payout file. The payment batch module 145 stores the payout file in at least one client database.

In one example, each of a set of payment transactions comprised in a transaction bundle are selectively delegated to payment batches in a plurality of payment batches based on payment destination accounts associated with each of the plurality of payment batches and each of the set of payment transactions. The payment batching module 145 transmits the plurality of payment batches to the payment transaction processor module 150. The payment transaction processor module 150 processes the at least one payment transaction in the plurality of payment batches on a batch basis.

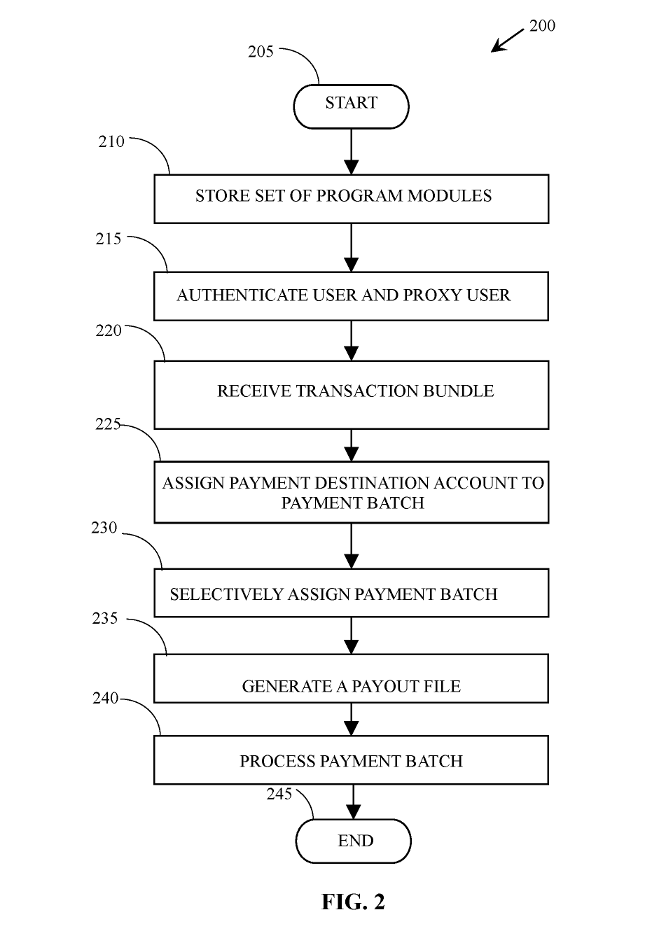

FIG. 2 is a flowchart of a method of batch processing payment transactions, in accordance with an embodiment of the present invention. The method 200 is implemented in an environment comprising a user terminal, a client device, a network, and a server. The client device and the user terminal communicates with the server via the network. Examples of the network comprise local area networks, mobile networks, internet, wide area networks and Bluetooth networks. At least one user communicates with the server via the user terminal. The user terminal is at least one of a personal computer, a tablet computer, a laptop, a smartphone, and a smart television. Further, the client device hosts a plurality of application programs. The plurality of application programs communicates with the server via one or more Application Programming Interface gateways (API). The API gateways communicate with the server via at least one proxy user. In one example, the plurality of application programs in the client device, the user terminal, and the server are provided interoperability by Representational State Transfer (REST) based web services. The plurality of application programs comprises mobile applications, eCommerce websites, electronic wallet applications, payment processing websites, credit card applications, debit card applications, banking websites, web form applications, and electronic customer relationship management software. The environment hosts a system for batch processing payment transactions received from the at least one proxy user. In one example, the system for batch processing payment transactions is implemented in the server. The server comprises a memory unit and a processor. The method 200 begins at step 205.

At step 210, the memory unit stores a set of program modules comprising an input module, a payment batching module, a payment transaction processor module, and an authorization module. Further, the memory unit stores a plurality of permission levels associated with the proxy user, a plurality of trusted API keys and a plurality of trusted user credentials. The processor executes the set of program modules stored in the memory unit.

At step 215, the processor executes the authorization module to authenticate a user and a proxy user. The processor, via the authorization module, receives at least one user credential from the user. Examples of the user credential include, but are not limited to passwords, usernames, fingerprints, retinal scans, voice samples, biometric parameters, and facial images. The authorization module compares the user credential with each of the plurality of trusted user credentials stored in the memory unit. If the user credential is identical to at least one of the plurality of trusted user credentials, then the authorization module authenticates the user. After authenticating the user, the authorization module generates a session key for the user. The session key has a pre-defined lifetime. After expiry of the predefined lifetime, the authorization module deactivates the session key. In one example, the predefined lifetime is fifteen minutes. The user is enabled to set the session key to at least one application program in the client device. Furthermore, the user, after being authenticated, is enabled to authorize the proxy user to the server. In one example, the authorization module generates an Application Programming interface key (API key) for the proxy user. The API key comprises information regarding permission levels associated with the proxy user. An example of a permission level includes, but is not limited to a permission to update a plurality of electronic monetary accounts, a permission to process a plurality of electronic sales transactions, and a permission for the proxy user to generate a payout file. The authorization module stores the API key in the memory unit.

In another example, the authorization module is configured to receive an API key from at least one proxy user. The authorization module compares the API key to each of the plurality of trusted API keys stored in the memory unit. Further, the authorization module authenticates the proxy user based on the API key being identical to at least one of the plurality of trusted API keys. The proxy user, after being authenticated is enabled to transfer at least one transaction bundle into the server via the input module.

At step 220, the processor via the input module receives from the at least one proxy user, information associated with at least one transaction bundle. The transaction bundle comprises at least one payment transaction comprising a first payment amount to be electronically transferred to a first payment destination account. Examples of first payment destination include electronic wallet accounts, bank accounts, debit card balances, credit card balances, and store credits. In one example, the transaction bundle comprises a plurality of payment transactions comprising a tax payment transaction, a user payment transaction and a merchant payment transaction. In an exemplary illustration of the present invention, the tax payment transaction comprises a tax amount to be transferred to a tax account. In another exemplary illustration of the present invention, the user payment transaction comprises a user payment amount to be electronically transferred to a user bank account. In yet another exemplary illustration of the present invention, the merchant payment transaction comprises a merchant payment amount to be electronically transferred to a merchant bank account. In one example, the payment transactions are processed in a batch basis by a combination of a payment batching module and a payment transaction processor module.

At step 225, the payment batching module assigns a second payment destination account to a payment batch among a plurality of payment batches. In one example, each payment batch among the plurality of payment comprises a second payment amount to be electronically transferred to the second payment destination account.

At step 230, the payment batching module selectively assigns the at least one payment transaction to the payment batch, based on the first payment destination account being identical to the second payment destination account. In one example, each of a set of payment transactions comprised in a transaction bundle are delegated to payment batches in a plurality of payment batches. The payment transactions are delegated based on payment destination accounts associated with the payment transactions being identical to the payment destination accounts associated with the payment batches.

At step 235, the payment batching module writes the plurality of payment batches into a payout file. Further, the payment batching module transmits the plurality of payment batches to the payment transaction processor module.

At step 240, the payment transaction processor module processes the at least one payment transaction in the plurality of payment batches on a batch basis.

The method 200 ends at step 245.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A system for batch processing payment transactions, the system comprising:
a memory unit to store a set of program modules;
a processor coupled with the memory unit executes the set of program modules, wherein the set of program modules comprises:
an input module, executed by the processor, configured to receive from at least one proxy user information associated with at least one transaction bundle, wherein the at least one transaction bundle comprises at least one payment transaction comprising a payment amount to be electronically transferred to a first payment destination account;
a payment batching module, executed by the processor, configured to:
assign a second payment destination account to a payment batch among a plurality of payment batches, and
selectively assign the at least one payment transaction to the payment batch, based on the first payment destination account being identical to the second payment destination account; and
a payment transaction processor module, executed by the processor, configured to process the at least one payment transaction in the plurality of payment batches on a batch basis.

2. The system of claim 1, wherein the memory unit further stores a plurality of permission levels for the at least one proxy user, a plurality of trusted Application Programming Interface (API) keys and a plurality of trusted user credentials.

3. The system of claim 2, wherein the memory unit further comprises an authorization module executed by the processor, configured to:
receive at least one user credential from at least one user;
compare the at least one user credential with each of the plurality of trusted user credentials;
authenticate the at least one user based on the at least one user credential being identical to at least one of the plurality of trusted user credentials;
receive from the at least one user, an instruction to authorize a first proxy user;
generate a first API key for the first proxy user;
store the first API key in the memory unit; and
generate at least one permission level for the first proxy user.

4. The system of claim 3, wherein the authorization module, executed by the processor, is further configured to:
receive an API key from the at least one proxy user;
compare the API key to each of the plurality of trusted API keys; and
authenticate the at least one proxy user based on the API key being identical to at least one of the plurality of trusted API keys.

5. The system of claim 1, wherein the at least one proxy user is associated with at least one Application Programming Interface (API) endpoint.

6. The system of claim 1, wherein the payment batching module is further configured to write the plurality of payment batches into a payout file.

7. The system of claim 5, wherein the at least one API endpoint produces information in Representational State Transfer (REST) style.

8. The system of claim 3, wherein the authorization module generates a session key for the at least one user.

9. The system of claim 8, wherein the session key expires within a predefined time interval of generation of the session key.

10. The system of claim 4, wherein the API key comprises information regarding with a plurality of permission levels associated with the at least one proxy user.

11. A method of batch processing payment transactions, the method comprising:
storing in a memory unit, a set of program modules;
receiving from at least one proxy user by a processor via an input module, information associated with at least one transaction bundle, wherein the at least one transaction bundle comprises at least one payment transaction comprising a payment amount to be electronically transferred to a first payment destination account;
assigning by the processor via a payment batching module, a second payment destination account to a payment batch among a plurality of payment batches;
selectively assigning by the processor via the payment batching module, the at least one payment transaction to the payment batch, based on the first payment destination account being identical to the second payment destination account; and
processing by the processor via a payment transaction processor module, the at least one payment transaction in the plurality of payment batches on a batch basis.

12. The method of claim 11, wherein the memory unit further stores a plurality of trusted Application Programming Interface (API) keys and a plurality of trusted user credentials.

13. The method of claim 12, wherein the method further comprises:
receiving at the processor, via an authorization module, at least one user credential from at least one user;
comparing at the processor, via the authorization module, the at least one user credential with each of the plurality of trusted user credentials;
authenticating at the processor, via the authorization module, the at least one user based on the at least one user credential being identical to at least one of the plurality of trusted user credentials;
receiving at the processor, via the authorization module, from the at least one user, an instruction to authorize a first proxy user;
generating at the processor, via the authorization module, a first API key for the first proxy user;
storing in the memory unit the first API key; and
generating by the processor, at least one permission level for the first proxy user.

14. The method of claim 13, further comprising:
receiving by the processor via the authorization module, an API key from the at least one proxy user;
comparing by the processor via the authorization module the API key to each of the plurality of trusted API key; and
authenticating by the processor via the authorization module the at least one proxy user based on the API key being identical to at least one of the plurality of trusted API key.

15. The method of claim 11, wherein the at least one proxy user is associated with at least one Application Programming Interface endpoint.

16. The method of claim 1, wherein the method further comprises writing by the processor, via the payment batching module, the plurality of payment batches into a payout file.

17. The method of claim 15, wherein the at least one API endpoint produces information in Representational State Transfer (REST) style.

18. The method of claim 13, wherein the authorization module generates a session key for the at least one user.

19. The method of claim 18, wherein the session key expires within a predefined time interval of generation of the session key.

20. The method of claim 14, wherein the API key comprises information regarding a plurality of permission levels associated with the at least one proxy user.
